(19) United States
(12) Patent Application Publication
(10) Pub. No.: US 2024/0161944 A1
(43) Pub. Date: May 16, 2024

(54) CONDUCTIVE CABLE CONFIGURATION FOR USE IN A WELLBORE

(71) Applicant: Halliburton Energy Services, Inc., Houston, TX (US)

(72) Inventors: Jeffrey G. Frey, Tulsa, OK (US); Terry Lynn Glasscock, Tulsa, OK (US)

(21) Appl. No.: 18/358,723

(22) Filed: Jul. 25, 2023

Related U.S. Application Data
(60) Provisional application No. 63/425,945, filed on Nov. 16, 2022.

(51) Int. Cl. H01B 7/29; H01B 7/00; H01B 7/04; H01B 7/24

(52) U.S. Cl. CPC H01B 7/292; H01B 7/0072; H01B 7/046; H01B 7/24

(57) ABSTRACT

A cable comprising: an electrical conductor; an elastic insulation positioned around the electrical conductor; and a nonconductive jacket positioned around the elastic insulation, wherein the nonconductive jacket is to provide containment of the elastic insulation to limit thermal expansion of the elastic insulation.

### BACKGROUND

Wells for hydrocarbon recovery can often rely on pressure from downhole to move the hydrocarbons to the surface of the wellbore. However, certain hydrocarbons are too heavy to be moved to the surface of the wellbore just relying on downhole pressure. Thus, electrical submersible pumps (ESPs) can be positioned in the wellbore to assist in moving the hydrocarbons to the surface. Such ESPs need a supply of power for operation.

Such ESPs need a conductive cable to supply power and/or communication between components at the surface of the wellbore and components positioned downhole in the wellbore. However, current conventional conductive cables lack reliability to be effective downhole.

### BRIEF DESCRIPTION OF THE DRAWINGS

Embodiments of the disclosure may be better understood by referencing the accompanying drawings.

FIG. 1 depicts an example cable, according to some embodiments.

FIG. 2 depicts an example well system having an ESP, according to some embodiments.

FIG. 3 depicts a flowchart of example operations for manufacturing an example cable for an ESP, according to some embodiments.

FIG. 4 depicts a flowchart of example operations for using an example cable for an ESP, according to some embodiments.

### DESCRIPTION

The description that follows includes example systems, methods, techniques, and program flows that embody aspects of the disclosure. However, it is understood that this disclosure may be practiced without these specific details. For instance, this disclosure refers to a cable for powering and/or communicating with an ESP in illustrative examples. Aspects of this disclosure can also be applied to other applications (e.g., other wellbore applications and/or applications at the surface).

Example embodiments may improve reliability and run time in metal encapsulated motor lead extension and ESP cables. Some example embodiments may include a cable that is used to power and/or communicate with an ESP positioned in a wellbore. As further described below, a PEEK core jacket may be included to provide compression and limit thermal expansion of an underlying elastomer cover the electrical conductor. Additionally, compression by the PEEK core jacket may reduce partial electrical discharge. The PEEK core jacket also may provide a slick surface to assist with pulling and/or pushing the jacket into an outer layer (such as an outer metallic tube).

In a conventional configuration for a cable, a perfluoroalkoxy (PFA) insulation and jacket has been used as the primary insulator and protective jacket. However, PFA has a relatively low insulation resistance when compared to Ethylene Propylene (EP) (such as EP Diene Monomer (EPDM) (which is a form of synthetic rubber insulation). Testing has shown that premature electrical failures may occur because of weakness in the PFA insulation. Such electrical failures may be a result of partial discharge. In contrast, example embodiments may use an elastic insulation (such as EPDM Insulation) which is much better electrically. Some implementations may include a polyimide film over the electrical conductor to provide even further electrical improvements.

Some implementations may use the cable in locations having elevated temperatures. For example, the cable can be located in a wellbore and used for powering and/or communicating with an ESP. To account for elevated temperatures, in some implementations, the elastic insulation may have a reduced thickness to limit thermal expansion that may occur in response to the elevated temperatures.

Thus, example implementations may include an extruded nonconductive jacket (such as a PEEK jacket) that may serve several purposes. For instance, the PEEK jacket may provide mechanical protection to the underlying elastic insulation. Additionally, the PEEK jacket may provide containment to the underlying elastic insulation in the event of thermal expansion from heat or decompression. The PEEK jacket may also provide some forgiveness for severe thermal expansion or decompression by displacing and absorbing the thermal expansion. Further, the PEEK jacket may provide compression to the elastic insulation to mitigate partial electrical discharge that may exist. The PEEK jacket may also provide a hard and slick surface for pulling into the metal tubing and may stiffen the single conductor to help with pushing and/or pulling through the metal tubing.

Accordingly, example implementations may address issues with a metal clad motor lead extension (MLE) cable that have caused premature failure and questionable reliability. Thus, example implementations may provide cables having less partial discharge and cables with increased usable life span and reliability. Additionally, example implementations may improve assembly, packaging, handling and installation processes of the cable.

### Example Conductive Cable

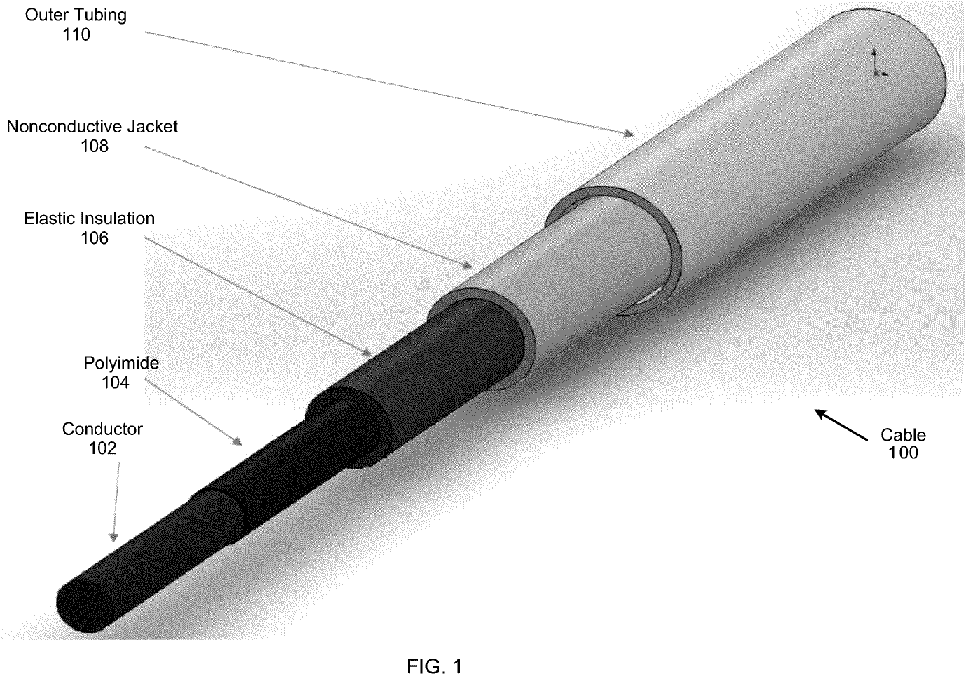

FIG. 1 depicts an example cable, according to some embodiments. FIG. 1 depicts a cable 100 having a number of layers, films, conduits, wraps, etc. The cable 100 includes a conductor 102. In some implementations, the conductor 102 may be a copper conductor. For example, the conductor 102 may be soft drawn bare copper. In some implementations, the conductor 102 may have an outer diameter of 5.64 millimeters (mm) (0.204 inches). In some other implementations, the conductor 102 may have an outer diameter in different ranges (such as 5-7 mm, 4-8 mm, etc.).

In some implementations, the cable 100 may include a polyimide film 104 that may be positioned around the conductor 102. In some implementations, the polyimide film 104 may be positioned around the conductor 102 using a tape wrap. In some other implementations, the polyimide film 104 may be positioned around the conductor 102 via extrusion. Also, the polyimide film 104 may be comprised of multiple layers. For example, the polyimide film 104 may include two layers such that there is approximately 49% overlap in opposing directions. Additionally, while described as being composed of polyimide, the film 104 may be any other type of high dielectric material. In some implementations, the polyimide film 104 may have a wall thickness of 0.203 mm (0.008 inches). In some other implementations, the polyimide film 104 may have a wall thickness in different ranges (such as 0.1-0.3 mm, 0.05-1.5 mm, etc.). In some implementations, the polyimide film 104 may have an outer diameter of 5.64 mm (0.222 inches). In some other implementations, the polyimide film 104 may have an outer diameter in different ranges (such as 4-6 mm, 3-7 mm, etc.).

The cable 100 may also include an elastic insulation 106 positioned around the polyimide film 104. The elastic insulation 106 may be composed of any type of material having a low swell or expansion in response to high temperatures. In some implementations, the elastic insulation 106 may be an Ethylene Propylene (EP) insulation (such as Ethylene Propylene Diene Monomer (EPDM) insulation).

In some implementations, the elastic insulation 106 may be Ethylene Propylene Diene Monomer (EPDM) insulation. Other examples of the elastic insulation 106 include a Polytetrafluoroethylene (PTFE) insulation, Per- and polyfluoroalkyl substances (PFASs), etc. The elastic insulation 106 may be positioned around the polyimide film 104 using a number of different processes. For example, the elastic insulation 106 may be extruded over the polyimide film 104. In some implementations, the elastic insulation 106 may have a wall thickness of 1.1 mm (0.045 inches). In some other implementations, the elastic insulation 106 may have a wall thickness in different ranges (such as 0.5-2.0 mm, 1.0-1.5 mm, etc.). In some implementations, the elastic insulation 106 may have an outer diameter of 8.0 mm (0.314 inches). In some other implementations, the elastic insulation 106 may have an outer diameter in different ranges (such as 7-9 mm, 8-10 mm, etc.).

The cable 100 may also include a nonconductive jacket 108 positioned around the elastic insulation 106. For example, the nonconductive jacket 108 may be a PEEK jacket composed of any other type of nonconductive material. The nonconductive jacket 108 may be composed of other materials of high density and high dielectric strength and that is robust and flexible. For instance, the nonconductive jacket 108 may be any type of thermoplastic polymer jacket. The nonconductive jacket 108 may be positioned around the elastic insulation 106 using a number of different processes. For example, the nonconductive jacket 108 may extrude over the elastic insulation 106.

The nonconductive jacket 108 may provide mechanical protection to the elastic insulation 106. The nonconductive jacket 108 may also provide containment of the elastic insulation 106 in the event that there is thermal expansion of the elastic insulation 106 from heat or decompression. The nonconductive jacket 108 may also mitigate partial electrical discharge based on its compression of the elastic insulation 106. In some implementations, the composition of the nonconductive jacket 108 is such that the jacket may provide a hard and slick surface to assist with pulling and pushing the nonconductive jacket 108 through an outer tubing 110. In some embodiments, a surface of the nonconductive jacket 108 may have a surface roughness that is less than a smoothness threshold.

In some implementations, the nonconductive jacket 108 may have a wall thickness of 1.02 mm (0.040 inches). In some other implementations, the nonconductive jacket 108 may have a wall thickness in different ranges (such as 0.5-1.5 mm, 1.0-2.0 mm, etc.). In some implementations, the nonconductive jacket 108 may have an outer diameter of 10.6 mm (0.396 inches). In some other implementations, the nonconductive jacket 108 may have an outer diameter in different ranges (such as 9-11 mm, 10-12 mm, etc.).

The cable 100 may also include an outer tubing 110 positioned around the nonconductive jacket 108. In some implementations, the outer tubing 110 may be a metallic tubing. For example, the outer tubing 110 may be a Monel tubing that is composed of a nickel-copper alloy. In other implementations, the outer tubing 110 may be a nonmetallic tubing. In some embodiments, the outer tubing 110 may be positioned around the nonconductive jacket 108 by pulling and/or pushing the nonconductive jacket 108 through the outer tubing 110.

### Example System

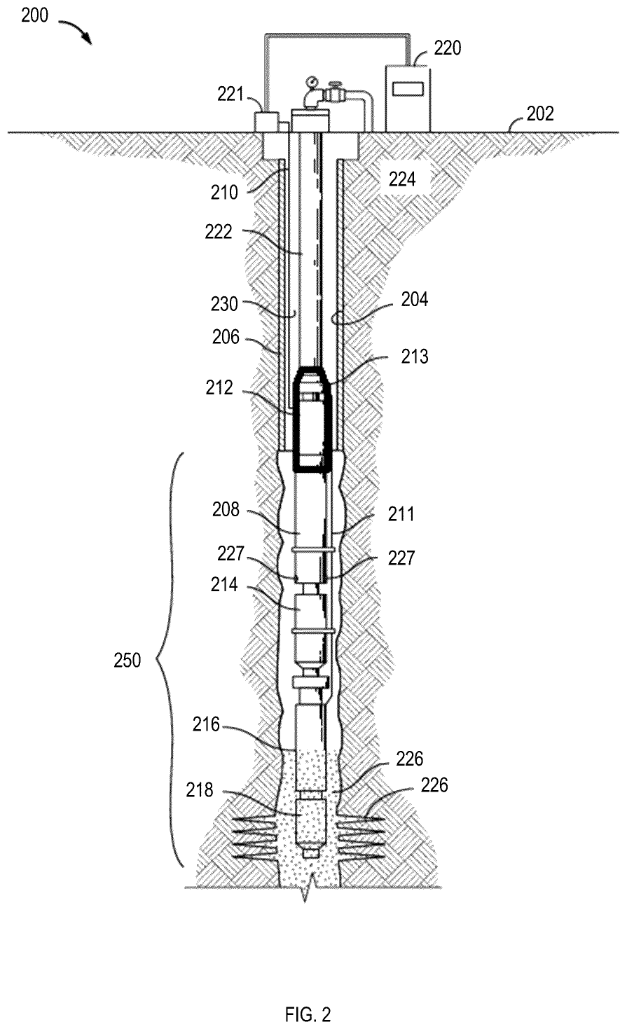

An example system (application) in which a conductive cable (as described herein) may be used is now described. FIG. 2 depicts an example well system having an ESP, according to some embodiments. FIG. 2 depicts a well system 200. While the well system 200 illustrates a land-based subterranean environment, example implementations contemplate any well site environment including a subsea environment. In one or more embodiments, any one or more components or elements may be used with subterranean operations equipment located on offshore platforms, drill ships, semi-submersibles, drilling barges and land-based rigs.

In some embodiments, the well system 200 is positioned (at least partially) in a wellbore 204 below a surface 202 in a formation 224. The wellbore 204 may comprise a vertical, deviated, horizontal, or any other type of wellbore. The wellbore 204 may be defined in part by a casing 206 that may extend from the surface 202 to a selected downhole location. Portions of the wellbore 204 that do not comprise the casing 206 may be referred to as open hole.

Various types of hydrocarbons or fluids may be pumped from the wellbore 204 to the surface 202 using a pump system 250 disposed or positioned downhole, for example, within, partially within, or outside the casing 206 of the wellbore 204. In some implementations, the pump system 250 may comprise an electrical submersible pump (ESP) system. The well system 200 may include an electrical cable 210 and an electrical cable 211. In some implementations, at least one of the electrical cable 210 and the electrical cable 211 may be configured as depicted in FIG. 1 (described above).

The pump system 250 may comprise a pump 208, a pump flow control system 212, a seal or equalizer 214, a motor 216, and a sensor 218. The pump 208 may be an ESP, including but not limited to, a multi-stage centrifugal pump, a rod pump, a progressive cavity pump, any other suitable pump system or combination thereof. The pump 208 may transfer pressure to the fluid 226 or any other type of downhole fluid to propel the fluid from downhole to the surface 202 at a desired or selected pumping rate. The pump 208 may be coupled to a pump flow control system 212 comprising a housing 213. The motor 216 may, in some embodiments, be a permanent magnet motor (PMM) or a comparable motor to drive the pump 208 and may be coupled to at least a downhole sensor 218. The electrical cable 211 may be coupled to the motor 216. The electrical cable 210 may provide power to the motor 216 via the cable 211, transmit one or more control or operation instructions from the controller 220 to the motor 216, or both. The electrical cable 210 may be communicatively coupled to the controller 220 and also to a flowmeter 221 disposed at the surface 202. The flowmeter 221 may be replaced with any suitable sensor utilized to measure a parameter of the fluid 226.

The fluid 226 may be a multi-phase wellbore fluid comprising one or more hydrocarbons. For example, the fluid 226 may be a two-phase fluid that comprises a gas phase and a liquid phase from a wellbore or reservoir in the formation 224. The fluid 226 may enter the wellbore 204, the casing 206 or both through one or more perforations in the formation 224 and flow uphole to one or more intake ports 227 of the pump system 250, wherein the one or more intake ports 227 may be disposed at a distal end of the pump 208. The pump 208 may transfer pressure to the fluid 226 by adding kinetic energy to the fluid 226 via centrifugal force and converting the kinetic energy to potential energy in the form of pressure. The pump 208 may lift the fluid 226 to the surface 202.

The motor 216 may include an electrical submersible motor configured or operated to turn the pump 208 and may, for example, be a two or more-pole, three-phase squirrel cage induction motor or a permanent magnet motor (PMM). However, other motor configurations may be possible. A production tubing section 222 may couple to the pump 208 using one or more connectors 228 or may couple directly to the pump 208. Any one or more production tubing sections 222 may be coupled together to extend the pump system 250 into the wellbore 204 to a desired or specified location.

Components of the fluid 226 may be pumped from the pump 208 through the production tubing 222 to the surface 202 for transfer to a storage tank, a pipeline, transportation vehicle, any other storage, distribution or transportation system and any combination thereof. In some embodiments, the pump flow control system 212 may include a fixed perforated disk and a rotatable perforated disk. During operations, the rotatable disk may be positioned to substantially throttle or halt the flow of fluid through the pump flow control system 212. If gas is present with the fluid 226, a reduced flow rate will increase the intake pressure at the bottom of the pump 208. The increased intake pressure may force the fluid 226 to flow in the liquid phase, despite a presence of dissolved gas within. This may improve the performance of the pump 208 and reduce an incidence rate of gas-lock events. Additionally, reducing the flow rate at the pump flow control system 212 may deliver near-instant results, whereas a significant delay between action and effects may be seen through flow rate reductions initiated by valves at the surface 202, or by pump speed changes to the pump 208.

### Example Operations

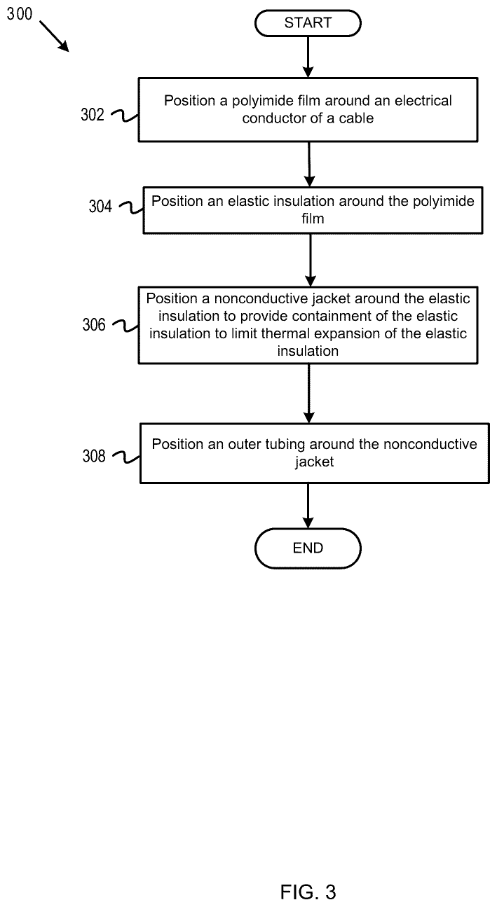

FIG. 3 depicts a flowchart of example operations for manufacturing an example cable for an ESP, according to some embodiments. A flowchart 300 of FIG. 3 is described in reference to the cable 100 of FIG. 1. Operations of the flowchart 300 start at block 302.

At block 302, a polyimide film is positioned around an electrical conductor of a cable. For example, with reference to FIG. 1, the polyimide film 104 is positioned around the conductor 102. For instance, the polyimide film 104 may be tape wrapped over the conductor 102.

At block 304, an elastic insulation is positioned around the polyimide film. For example, with reference to FIG. 1, the elastic insulation 106 may be positioned around the polyimide film 104. The elastic insulation 106 may be composed of any type of material having a low swell or expansion in response to high temperatures. In some implementations, the elastic insulation 106 may be an Ethylene Propylene (EP) insulation (such as Ethylene Propylene Diene Monomer (EPDM) insulation). Other examples of the elastic insulation 106 include a Polytetrafluoroethylene (PTFE) insulation, Per- and polyfluoroalkyl substances (PFASs), etc. The elastic insulation 106 may be positioned around the polyimide film 104 using a number of different processes. For example, the elastic insulation 106 may be extruded over the polyimide film 104.

At block 306, a nonconductive jacket is positioned around the elastic insulation to provide containment of the elastic insulation to limit thermal expansion of the elastic insulation. For example, with reference to FIG. 1, the nonconductive jacket 108 can be positioned around the elastic insulation 106. In some implementations, the nonconductive jacket 108 may be extruded over the elastic insulation 106.

At block 308, an outer tubing is positioned around the nonconductive jacket. For example, with reference to FIG. 1, the outer tubing 110 may be positioned around the nonconductive jacket 108. In some embodiments, the outer tubing 110 may be positioned around the nonconductive jacket 108 by pulling and/or pushing the nonconductive jacket 108 through the outer tubing 110. Operations of the flowchart 300 are complete.

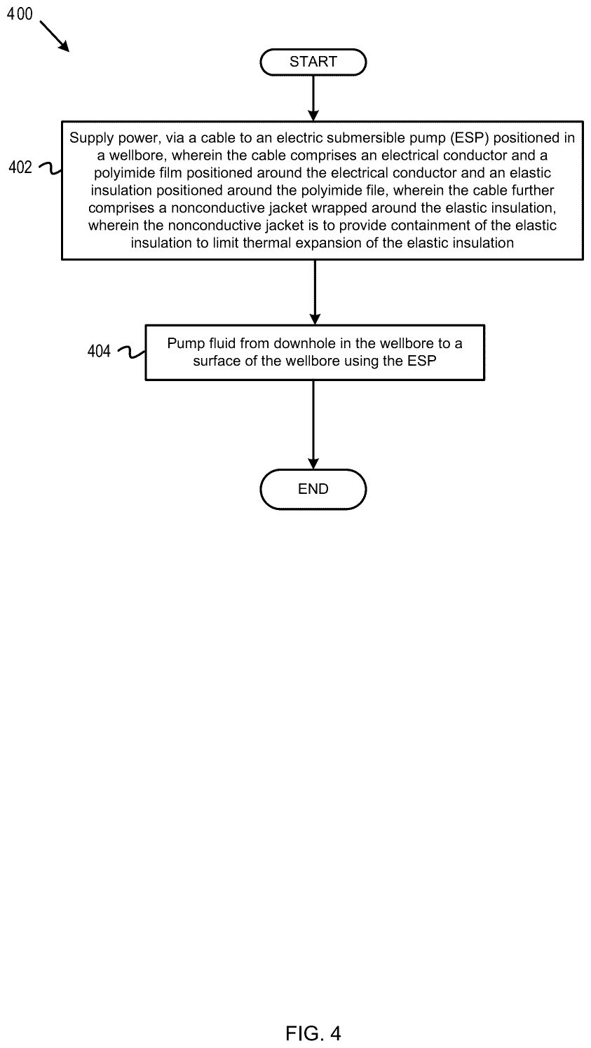

An example operation for using an example cable is now described. FIG. 4 depicts a flowchart of example operations for using an example cable for an ESP, according to some embodiments. A flowchart 400 of FIG. 4 is described in reference to the cable 100 of FIG. 1 and the well system 200 of FIG. 2. Operations of the flowchart 400 start at block 402.

At block 402, power is supplied, via a cable to an electric submersible pump (ESP) positioned in a wellbore. The cable comprises an electrical conductor and a polyimide film positioned around the electrical conductor and an elastic insulation positioned around the polyimide film, wherein the cable further comprises a thermoplastic polymer jacket wrapped around the elastic insulation, wherein the thermoplastic polymer jacket is to limit thermal expansion of the elastic insulation to less than an expansion threshold. For example, with reference to the well system 200 of FIG. 2, the cable 211 may supply power to the motor 216. In some implementations, the cable 210 and/or the cable 211 may supply power and/or be a communication medium between the components downhole and components at the surface of the wellbore.

At block 404, fluid is pumped from downhole in the wellbore to a surface of the wellbore using the ESP. For example, with reference to the well system of FIG. 2, the pump 208 may propel the fluid from downhole to the surface 202 based on power supplied by the electrical cables 210 and 211. Operations of the flowchart 400 are complete.

While the aspects of the disclosure are described with reference to various implementations and exploitations, it will be understood that these aspects are illustrative and that the scope of the claims is not limited to them. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order.

### Example Embodiments

Embodiment #1: A cable comprising: an electrical conductor; an elastic insulation positioned around the electrical conductor; and a nonconductive jacket positioned around the elastic insulation, wherein the nonconductive jacket is to provide containment of the elastic insulation to limit thermal expansion of the elastic insulation.

Embodiment #2: The cable of Embodiment #1, wherein the nonconductive jacket comprises a thermoplastic polymer jacket.

Embodiment #3: The cable of one or more of Embodiments #1-2, wherein the elastic insulation comprises Ethylene Propylene insulation.

Embodiment #4: The cable of one or more of Embodiments #1-3, wherein the elastic insulation comprises Ethylene Propylene Diene Monomer insulation.

Embodiment #5: The cable of one or more of Embodiments #1-4, wherein a surface of the nonconductive jacket has a surface roughness that is less than a smoothness threshold.

Embodiment #6: The cable of one or more of Embodiments #1-5, further comprising an outer tubing positioned around the nonconductive jacket.

Embodiment #7: The cable of Embodiment #6, wherein the outer tubing comprises a metallic tubing.

Embodiment #8: The cable of Embodiment #6, wherein the outer tubing comprises a non-metallic tubing.

Embodiment #9: The cable of one or more of Embodiments #1-8, wherein the nonconductive jacket comprises a PEEK jacket.

Embodiment #10: The cable of one or more of Embodiments #1-9, further comprising a polyimide film positioned around the electrical conductor and between the electrical conductor and the elastic insulation.

Embodiment #11: The cable of one or more of Embodiments #1-10, wherein the cable is to be coupled to supply power to an electric submersible pump (ESP).

Embodiment #12: A method for manufacturing a cable, the method comprising: positioning an elastic insulation around an electrical conductor of the cable; and positioning around the elastic insulation a nonconductive jacket to provide containment of the elastic insulation to limit thermal expansion of the elastic insulation.

Embodiment #13: The method of Embodiment #12, further comprising: positioning a polyimide film around the electrical conductor between the elastic insulation and the electrical conductor.

Embodiment #14: The method of one or more of Embodiments #12-13, further comprising positioning an outer tubing around the nonconductive jacket.

Embodiment #15: The method of one or more of Embodiments #12-14, wherein a surface of the nonconductive jacket has a surface roughness that is less than a smoothness threshold.

Embodiment #16: The method of one or more of Embodiments #12-15, wherein the nonconductive jacket comprises a PEEK jacket.

Embodiment #17: A method comprising: supplying power, via a cable to an electric submersible pump (ESP) positioned in a wellbore, wherein the cable comprises an electrical conductor and an elastic insulation positioned around the electrical conductor, wherein the cable further comprises a nonconductive jacket positioned around the elastic insulation, wherein the nonconductive jacket is to provide containment of the elastic insulation to limit thermal expansion of the elastic insulation; and pumping fluid from downhole in the wellbore to a surface of the wellbore using the ESP.

Embodiment #18: The method of Embodiment #17, wherein a polyimide film is positioned around the electrical conductor between the electrical conductor and the elastic insulation.

Embodiment #19: The method of one or more of Embodiments #17-18, further comprising positioning an outer tubing around the nonconductive jacket.

Embodiment #20: The method of one or more of Embodiments #17-19, wherein the nonconductive jacket comprises a PEEK jacket.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

1. A cable comprising:
an electrical conductor;
an elastic insulation positioned around the electrical conductor; and
a nonconductive jacket positioned around the elastic insulation, wherein the nonconductive jacket is to provide containment of the elastic insulation to limit thermal expansion of the elastic insulation.

2. The cable of claim 1, wherein the nonconductive jacket comprises a thermoplastic polymer jacket.

3. The cable of claim 1, wherein the elastic insulation comprises Ethylene Propylene insulation.

4. The cable of claim 1, wherein the elastic insulation comprises Ethylene Propylene Diene Monomer insulation.

5. The cable of claim 1, wherein a surface of the nonconductive jacket has a surface roughness that is less than a smoothness threshold.

6. The cable of claim 1, further comprising an outer tubing positioned around the nonconductive jacket.

7. The cable of claim 6, wherein the outer tubing comprises a metallic tubing.

8. The cable of claim 6, wherein the outer tubing comprises a non-metallic tubing.

9. The cable of claim 1, wherein the nonconductive jacket comprises a PEEK jacket.

10. The cable of claim 1, further comprising a polyimide film positioned around the electrical conductor and between the electrical conductor and the elastic insulation.

11. The cable of claim 1, wherein the cable is to be coupled to supply power to an electric submersible pump (ESP).

12. A method for manufacturing a cable, the method comprising:
positioning an elastic insulation around an electrical conductor of the cable; and
positioning around the elastic insulation a nonconductive jacket to provide containment of the elastic insulation to limit thermal expansion of the elastic insulation.

13. The method of claim 12, further comprising:
positioning a polyimide film around the electrical conductor between the elastic insulation and the electrical conductor.

14. The method of claim 12, further comprising positioning an outer tubing around the nonconductive jacket.

15. The method of claim 12, wherein a surface of the nonconductive jacket has a surface roughness that is less than a smoothness threshold.

16. The method of claim 12, wherein the nonconductive jacket comprises a PEEK jacket.

17. A method comprising:
supplying power, via a cable to an electric submersible pump (ESP) positioned in a wellbore, wherein the cable comprises an electrical conductor and an elastic insulation positioned around the electrical conductor, wherein the cable further comprises a nonconductive jacket positioned around the elastic insulation, wherein the nonconductive jacket is to provide containment of the elastic insulation to limit thermal expansion of the elastic insulation; and
pumping fluid from downhole in the wellbore to a surface of the wellbore using the ESP.

18. The method of claim 17, wherein a polyimide film is positioned around the electrical conductor between the electrical conductor and the elastic insulation.

19. The method of claim 17, further comprising positioning an outer tubing around the nonconductive jacket.

20. The method of claim 17, wherein the nonconductive jacket comprises a PEEK jacket.
